(19) United States
(12) Patent Application Publication
(10) Pub. No.: US 2014/0185108 A1
(43) Pub. Date: Jul. 3, 2014

(54) METHOD OF PROCESSING DOCUMENT IN IMAGE FORMING APPARATUS AND IMAGE FORMING APPARATUS USING THE METHOD

(71) Applicant: Samsung Electronics Co., Ltd., Suwon-si (KR)

(72) Inventor: Ki-hun KIM, Suwon-si (KR)

(73) Assignee: Samsung Electronics Co., Ltd., Suwon-si (KR)

(21) Appl. No.: 14/132,322

(22) Filed: Dec. 18, 2013

(30) Foreign Application Priority Data
Dec. 28, 2012 (KR) 10-2012-0157205

(51) Int. Cl. H04N 1/333

(52) U.S. Cl. CPC H04N 1/33315
USPC 358/474

(57) ABSTRACT

A method of processing a document in an image forming apparatus and an image forming apparatus using the method are provided. The method includes receiving a user's setting regarding a determination standard for determining a mode to process a document from among a monochrome mode and a color mode, determining a mode to process the document from among the monochrome mode and the color mode based on the user's setting regarding the determination standard and a color ratio of scan data, and processing the document according to a result of the determination.

### CROSS-REFERENCE TO RELATED APPLICATIONS

This application is related to, and claims priority to Korean Patent Application No. 10-2012-0157205, filed on Dec. 28, 2012, in the Korean Intellectual Property Office, the disclosure of which is incorporated herein in its entirety by reference.

### BACKGROUND

1. Field

The present disclosure relates to a method of processing a document in an image forming apparatus and an image forming apparatus using the method, and more particularly, to a method that receives a user's setting regarding a determination standard for determining a mode to process a document from among a monochrome mode and a color mode and processes the document in an image forming apparatus by using the user's setting, and an image forming apparatus using the method.

2. Description of the Related Art

In general, an image forming apparatus such as a printer, a copier, a fax machine, or a multifunction printer performs copying and printing by scanning a document and forming an image on a print medium such as paper. Among image forming apparatus, an image forming apparatus that supports color images from among image forming apparatus may perform copying and printing in both color and black and white (hereinafter, referred to as monochrome). A user may select a monochrome mode or a color mode, and copying and printing may be performed according to the user's selection.

To attempt to reduce user inconvenience in selecting a monochrome mode or a color mode, a technology that automatically determines whether a document is a monochrome document or a color document and processes the document in a monochrome mode or a color mode in accordance with a result of the determination has been developed.

An image forming apparatus may include a user interface (UI) used by a user to control an operation of the image forming apparatus or to input data. The UI attempts to increase user convenience in controlling an operation of the image forming apparatus. As technology has developed and hardware and software used in an image forming apparatus has developed, and a UI of the image forming apparatus has been upgraded. As smart devices increase in use, a smart UI may be used as a UI of an image forming apparatus, in an attempt to improve user convenience. However, increased user convenience and improved efficiency in processing of documents are desired.

### SUMMARY

Exemplary embodiments of the present disclosure provide a method that receives a user's setting regarding a determination standard for determining a mode to process a document from among a monochrome mode and a color mode and processes the document in an image forming apparatus by using a result of the determination, and an image forming apparatus using the method. Technical problems to be solved by the present disclosure are not limited to the above-described technical problems and one of ordinary skill in the art will understand other technical problems from the disclosure herein.

According to an aspect of the present disclosure, a method of processing a document in an image forming apparatus is provided, the method including receiving a user's setting regarding a determination standard for determining a mode to process the document from among a monochrome mode and a color mode, generating scan data by scanning the document, determining a mode to process the document from among the monochrome mode and the color mode based on the user's setting regarding the determination standard and a color ratio of the scan data, and processing the document based on a result of the determination.

According to an aspect of the present disclosure, a computer-readable recording medium having embodied thereon a program for executing the method in a computer is provided.

According to an aspect of the present disclosure, an image forming apparatus is provided including a user interface (UI) that receives a user's setting regarding a determination standard for determining a mode to process a document from among a monochrome mode and a color mode, a scanning unit that generates scan data by scanning the document, a controller that determines a mode to process the document from among the monochrome mode and the color mode based on the user's setting regarding the determination standard and a color ratio of the scan data; and an image forming unit that processes the document according to a result of the determination.

### BRIEF DESCRIPTION OF THE DRAWINGS

The above and other features and advantages of the present disclosure will become more apparent by describing in detail exemplary embodiments thereof with reference to the attached drawings in which:

FIG. 1 illustrates an image forming apparatus according an exemplary embodiment;

FIG. 2 illustrates an exemplary controller of an image forming apparatus;

FIG. 3 illustrates a method of processing a document in the image forming apparatus according to an exemplary embodiment;

FIG. 4 illustrates an exemplary process of receiving a user's setting regarding a determination standard for determining a mode to process a document;

FIG. 5 illustrates an exemplary process of executing an editing window that receives a user's setting;

FIG. 6 illustrates an exemplary trim editing window that sets a reference color ratio according to a type of a document;

FIG. 7 illustrates an exemplary trim editing window that sets a document to be processed in any one of a monochrome mode and a color mode for an option of printing; and

FIG. 8 illustrates an exemplary process of determining a mode to process a document from among a monochrome mode and a color mode.

### DETAILED DESCRIPTION

Exemplary embodiments of the present disclosure are described more fully with reference to the accompanying drawings. The invention may, however, be embodied in many different forms and should not be construed as being limited to the embodiments set forth herein; rather these embodiments are provided so that this disclosure will be thorough and complete, and will fully convey the concept of the invention to one of ordinary skill in the art.

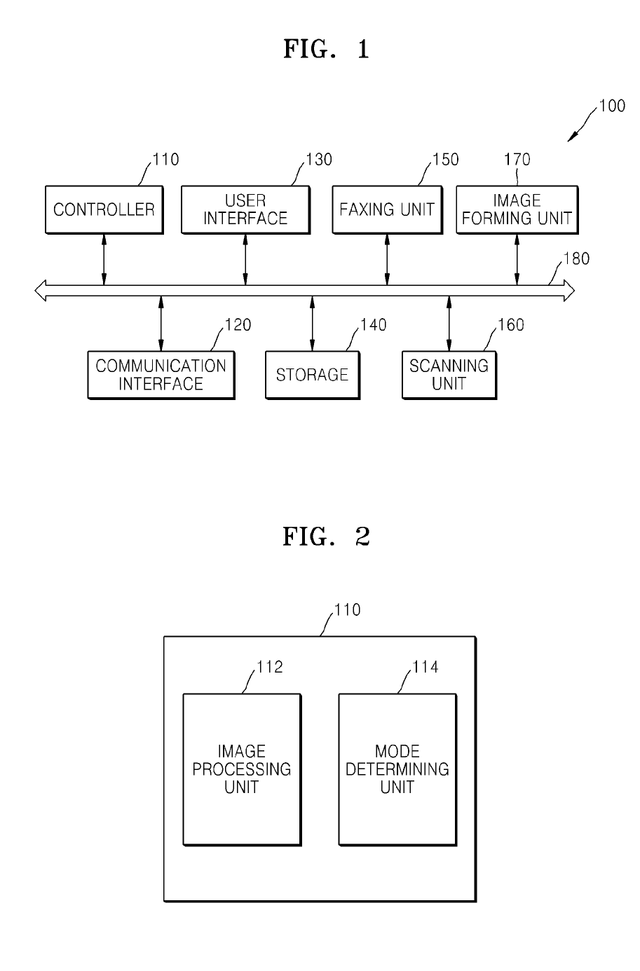

FIG. 1 illustrates an exemplary image forming apparatus 100 according to one or more embodiments. Referring to FIG. 1, the image forming apparatus 100 includes a controller 110, a communication interface 120, a user interface (UI) 130, a storage 140, a faxing unit 150, a scanning unit 160, and an image forming unit 170. The above elements transmit and/or receive various data to, or from, one another via a data bus 180. It will be understood by one of ordinary skill in the art that the image forming apparatus 100 may further include elements other than the above elements illustrated in FIG. 1.

The controller 110 may control one of more functions, including an overall function, of the image forming apparatus 100 and may be a microprocessor. The controller 110 may be divided into a plurality of processor modules separated according to functions and a main process module that generally manages the plurality of processor modules. The controller 110 may receive and/or transmit data from, or to, an external device through the communication interface 120. The controller 110 may identify information input from a user through the UI 130, and forms a UI image to output data processed by the controller 110 to the UI 130. The controller 110 controls various programs and data to be stored in the storage 140 and/or the various programs and the data stored in the storage 140 to be loaded. The controller 110 may control the faxing unit 150 to fax data, and/or may control the scanning unit 160 to scan a document. The controller 110 controls data loaded from the storage 140 to be compared with data processed by the controller 110, and/or data stored in the storage 140 to be transmitted to the image forming unit 170. The controller 110 controls the image forming unit 170 to process a document in a monochrome mode or a color mode. The controller 110 compares a color ratio of scan data generated by the scanning unit 160 with a reference color ratio according to a type of a document stored in the storage 140, determines whether to process the document in a monochrome mode or a color mode, and controls the image forming unit 170 to process the document in the determined mode. If a user's setting to process the document in any one of the monochrome mode and the color mode according to an option of printing is previously received through the UI 130, when there is an option of printing, the controller 110 is capable of determining, for example, whether to process the document in the monochrome mode or the color mode according to the user's setting and controls the image forming unit 170 to process the document in the determined mode.

The communication interface 120 may include a network module to connect to a network, a modem used to fax data, and a universal serial bus (USB) host module for forming a channel through which data flows with a portable storage medium, according to an application and a function of the image forming apparatus 100. Examples of an external device may include a server, a personal computer (PC) such as a laptop computer or a desktop computer, a mobile device such as a smartphone, a personal digital assistant, and a fax machine, which may be connected through a wired/wireless network to the image forming apparatus 100.

The UI 130 displays information to the user, and obtains an input signal from the user. The UI 130 may be any input/output device provided in the image forming apparatus 100 such as an electrostatic or piezoelectric touch screen, a display panel, a touchpad, a keyboard, a mouse, or a speaker. The UI 130 may be a touch screen.

The UI 130 receives various inputs about the use of the image forming apparatus 100 from the user. Before the image forming apparatus 100 is used, the UI 130 receives the user's various settings so as for the image forming apparatus 100 to suit the user's intention. For example, the UI 130 may display a determination standard for determining a mode to process a document from among a monochrome mode and a color mode, and may receive the user's setting regarding the determination standard for determining a mode to process the document from among the monochrome mode and the color mode. The user's various settings input by the user may be stored in the storage 140 and used, for example, when the image forming apparatus 100 operates.

The storage 140 stores programs and/or data generated according to an operation of the image forming apparatus 100 or used during the operation of the image forming apparatus 100. For example, the storage 140 stores data received from the external device, data input through the UI 130, data generated due to an operation (e.g., faxing, scanning, or copying) of the image forming apparatus 100, and various programs used to control the image forming apparatus 100. Data about the user's various settings input by the user through the UI 130 may be stored in the storage 140.

The faxing unit 150 faxes data by using a modem. The faxing unit 150 may convert image data written to a document into fax data to be transmitted by using the modem, or may transmit fax data received from the external device to the image forming unit 170 to be output to a print medium such as paper.

The scanning unit 160 generates scan data by scanning the image data written to the document, and transmits the scan data to the interface 120 to be connect to a network, to the storage 140 to be stored, to the faxing unit 150 to be faxed, or to the image forming unit 170 to be printed. That is, the scanning unit 160 may perform a function such as a scan to Server Message Block (SMB) function, a scan to File Transfer Protocol (FTP) function, a scan to Web Distributed Authoring and Versioning (WebDAV) function, a scan to e-mail function, a scan to PC function, or a scan to BOX function.

The scanning unit 160 generates scan data by scanning the document to which the image data is written under the control of the controller 110. When the image forming apparatus 100 is set to automatically determine whether a document is a monochrome document or a color document, the scanning unit 160 generates color scan data by performing color scanning on the document.

The image forming unit 170 forms an image and outputs copy and print data to a print medium such as paper. The image forming unit 170 may include hardware units that perform charging, exposure, developing, transferring, and fixing to output the copy and print data to the print medium and a software module that drives the hardware units. When the controller 110 determines a mode to process the document from among a monochrome mode and a color mode, the image forming unit 170 processes the document in the determined mode.

FIG. 2 illustrates an exemplary controller 110 of an image forming apparatus 100. Referring to FIG. 2, the controller 110 may include processor modules such as an image processing unit 112 and a mode determining unit 114. It will be understood by one of ordinary skill in the art that the controller 110 may further include general-purpose elements other than the processor modules illustrated in FIG. 2.

The image processing unit 112 obtains a color ratio of scan data generated by the scanning unit 160. When the image forming apparatus 100 is set to automatically determine whether a document is a monochrome document or a color document, the scanning unit 160 generates color scan data by performing color scanning on the document and the image processing unit 112 calculates a color ratio of the color scan data. That is, the image processing unit 112 obtains a color ratio of scan data by performing a series of processes.

When the image forming apparatus 100 is set, for example, to automatically determine whether the document is a monochrome document or a color document, the mode determining unit 114 determines a mode to process the document from among a monochrome mode and a color mode based on a determination standard for determining a mode to process the document from among the monochrome mode and the color mode and the color ratio of the scan data. The determination standard for determining a mode to process the document from among the monochrome mode and the color mode is stored in the storage 140 and may be preset through the UI 130 by the user.

For example, when the determination standard for determining a mode to process the document is a reference color ratio according to a type of the document, the color ratio of the scan data obtained by the image processing unit 112 is compared with the reference color ratio. When the color ratio of the scan data is equal to, or greater than, the reference color ratio, a mode is determined as the color mode, and when the color ratio of the scan data is less than the reference color ratio, a mode is determined as the monochrome mode. When the reference color ratio according to the type of the document is preset by the user through the UI 130, the reference color ratio may be stored in the storage 140 and is used by being loaded when the mode determining unit 114 operates.

When the user's setting to process the document in any one of the monochrome mode and the color mode according to an option of printing is previously received from the user through the UI 130, the determination standard for determining a mode to process the document may become the option of printing. When the user designates the option of printing when the image forming apparatus 100 is used, it may be determined whether to process the document in the monochrome mode or the color mode according to a document processing mode according to the option of printing preset by the user, and the image forming unit 170 is controlled to process the document in the determined mode.

The controller 110 may perform a first determining operation to process the document in the monochrome mode or the color mode by comparing the color ratio of the scan data generated by the scanning unit 160 with the reference color ratio stored in the storage 140, performs a second determining operation to process the document in the monochrome mode or the color mode when the user's setting to process the document in any one of the monochrome mode and the color mode according the option of printing is previously received from the user through the UI 130, and determines a mode to process the document by giving a priority to the mode determined in the second determining operation when the mode determined in the first determining operation and the mode determined in the second determining operation are different from each other. The controller 110 controls the image forming unit 170 to process the document in the determined mode.

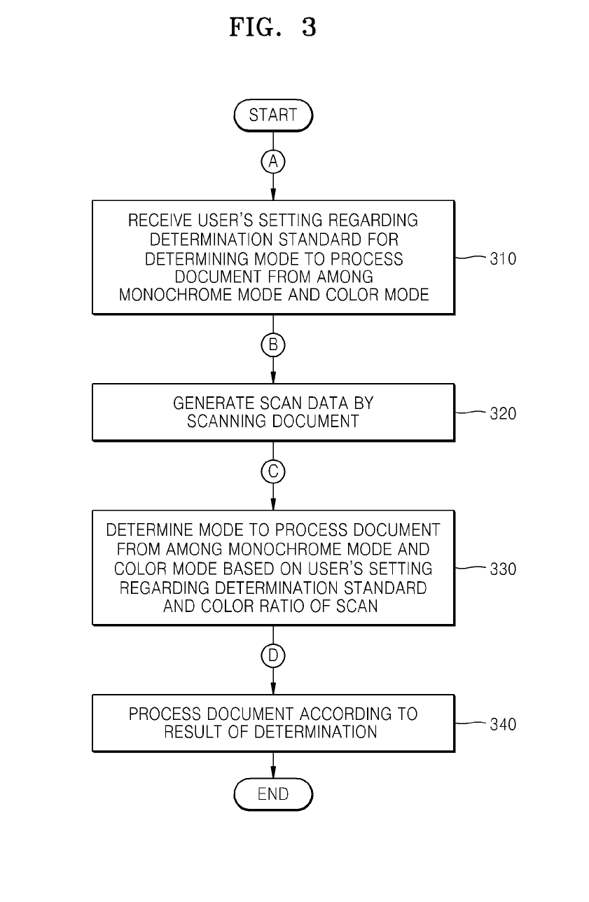

FIG. 3 is a flowchart illustrating a method of processing a document in an image forming apparatus according to one or more embodiments.

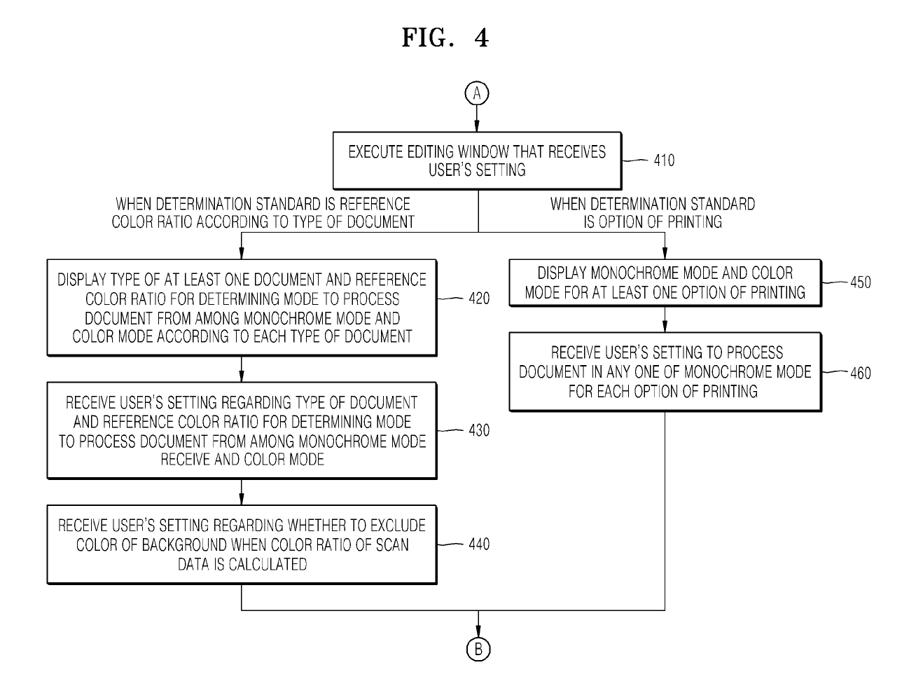

In operation 310, a user's setting regarding a determination standard for determining a mode to process a document from among a monochrome mode and a color mode is received. When the image forming apparatus 100 is set to automatically determine whether the document is a monochrome document or a color document, the document may be automatically determined to be a monochrome document or a color document without regard for a user's intention, and thus the document may be processed in a manner which the user does not want. To address this problem, the user's setting regarding the determination standard for determining a mode to process the document from among the monochrome mode and the color mode may be previously received from the user. Operation 310 is discussed in detail with reference to FIG. 4.

FIG. 4 is a flowchart illustrating an exemplary process of receiving a user's setting regarding a determination standard for determining a mode to process a document.

In operation 410, an editing window that receives the user's setting is executed. The user executes the editing window on the UI 130 to input the user's setting regarding the determination standard for determining a mode to process the document from among a monochrome mode and a color mode. The editing window may display at least one determination standard and the at least one determination standard for determining a mode to process the document from among the monochrome mode and the color mode may be set by the user.

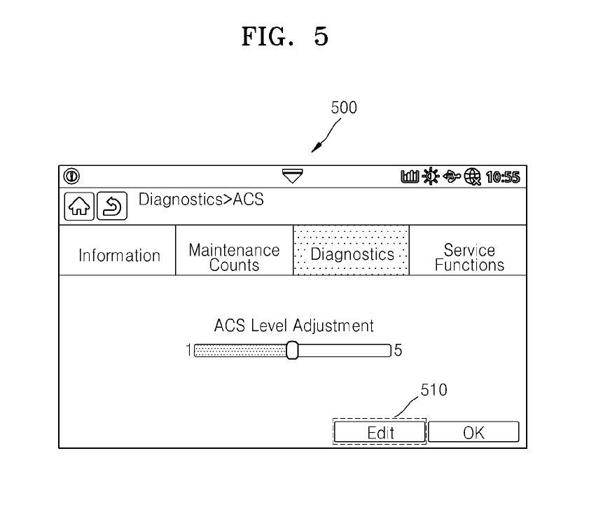

FIG. 5 illustrates an exemplary process of executing an editing window that receives a user's setting. The editing window may be executed by changing from a main page initially displayed on the UI 130 to a diagnostics menu page 500 or a tech menu page and, for example, clicking an edit button 510. When a color ratio is increased or reduced to automatically determine whether a document is a color document, a level of the color ratio may be simply adjusted from 1 to 5 by using ACS level adjustment. An actual value corresponding to each level may be previously determined when the image forming apparatus 100 is manufactured and thus may not be able to be readily changed. A general user may not know the actual value corresponding to each level and thus may not know what each level corresponds to. Accordingly, as illustrated in FIG. 5, the user may input a user's setting for various determination standards to correspond to the user's intention. For example, a user may execute the editing window that receives the user's setting by changing from the main page to the diagnostics menu page 500 or the tech menu page and then clicking the edit button 510. A trim editing window may be executed to input the user's setting, for example, for the various determination standards. When a determination standard to be set by the user is selected from among the various determination standards, the trim editing window that may input the user's setting regarding the selected determination standard may be executed. That is, for each of the various determination standards, the user's setting may be input by using the trim editing window that inputs the user's setting.

As illustrated in FIG. 4, operations 420 through 440 are operations of receiving the user's setting when a reference color ratio according to a type of the document is selected as the determination standard for determining a mode to process the document from among the monochrome mode and the color mode. Operations 450 and 460 are operations of receiving the user's setting when an option of printing is selected as the determination standard for determining a mode to process the document from among the monochrome mode and the color mode. Operations 420 through 440 and operations 450 and 460 may be performed in parallel e.g., simultaneously. Operations 450 and 460 may not be performed when the option of printing is not designated when the image forming apparatus 100 is used.

In operation 420, when the determination standard for determining a mode to process the document from among the monochrome mode and the color mode is the reference color ratio, a type of at least one document and the reference color ratio for determining a mode to process the document from among the monochrome mode and the color mode may be displayed on the trim editing window on the UI 130 for each type of the document. The type of the document and the reference color ratio according to each type of the document, which may be displayed on the trim editing window, denote current setting.

In operation 430, the user's setting regarding the type of the document and the reference color ratio for determining a mode to process the document from among the monochrome mode and the color mode for each type of the document is received from the user. Examples of the type of the document may include a text only document type, a text & image mixed document type, an image with color/monochrome mixed document type, an image with monochrome only type, an image with color only type, and an image for book copy type. The reference color ratio according to each type of the document may be set to be a value ranging from about 0% to about 100%. When a value is less than the reference color ratio, the mode may be set to be the monochrome mode.

In operation 440, when a background other than a portion of the document in which an image such as text is formed has a color, the user's setting regarding whether to exclude the color of the background when a color ratio of scan data is calculated may be further received. For example, when the background of the document has a color other than white and the color of the background is not important information, the color of the background may be disregarded. when the image forming apparatus 100 is set to automatically determine whether the document is a monochrome document or a color document, since the color of the background of the document is included when the color ratio of the scan data is calculated, the color of the background may be set to be excluded when the color ratio of the scan data is calculated when the color of the background needs to be excluded.

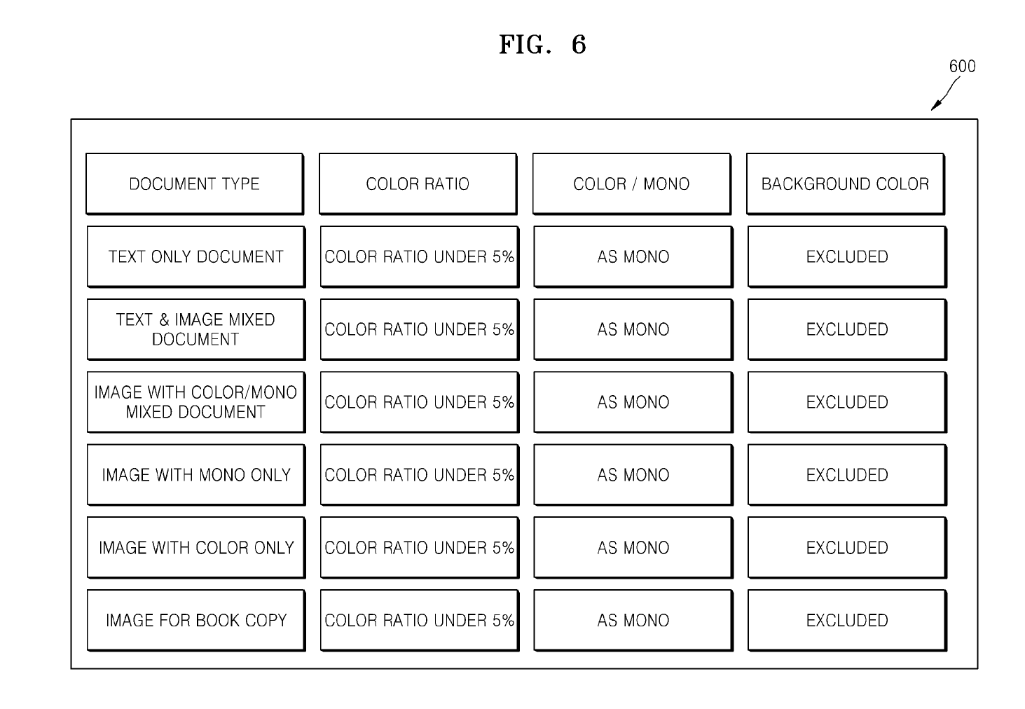

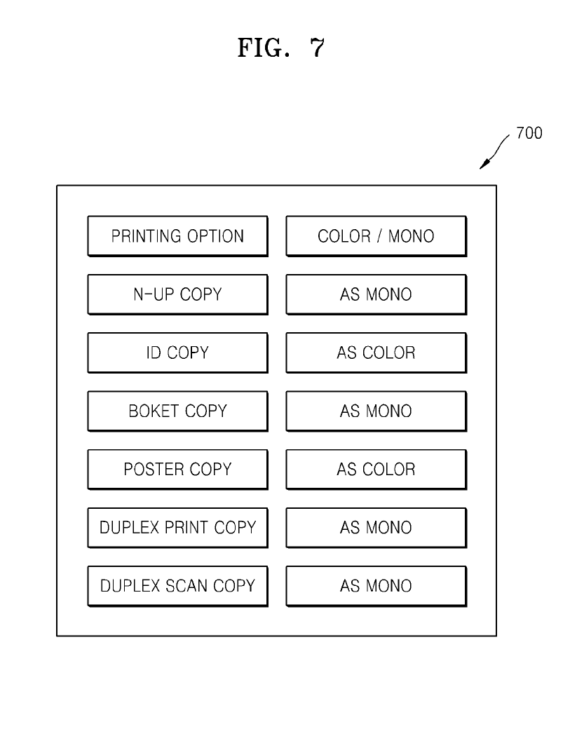

FIG. 6 illustrates an exemplary trim editing window 600 that sets a reference color ratio according to a type of a document. When a determination standard for determining a mode to process the document from among a monochrome mode and a color mode is a reference color ratio according to a type of the document, as described in operations 420 to 440, the trim editing window 600 may be displayed on the UI 130, as illustrated in FIG. 6.

As illustrated in FIG. 6, menus indicate, for example, a type of the document, a color ratio, color/mono, and a color of a background. Examples of the type of the document may include a text only document type, a text & image mixed document type, an image with color/monochrome mixed document type, an image with monochrome only type, an image with color only type, and an image for book copy type. A user may select any one of the examples of the type of the document, and may set whether to use color or monochrome and a color ratio according to the selected type of the document. A user may set whether to exclude the color of the background of the document when the color ratio of scan data is calculated. For example, in FIG. 6, when a text only document type is set as the type of the document and the color ratio of the scan data is less than 5%, a mode may be set to be the monochrome mode and the color of the background of the document is excluded when the color ratio of the scan data is calculated. Options to be selected in each menu may be selected by the user through the UI 130 and/or may be directly input by the user.

In operation 450, when the determination standard for determining a mode to process the document from among the monochrome mode and the color mode is an option of printing, the monochrome mode and the color mode for at least one option of printing may be displayed on the trim editing window of the UI 130. The monochrome mode and the color mode for the option of printing, which are displayed on the trim editing window, denote current setting.

In operation 460, the user's setting to process the document in any one of the monochrome mode and the color mode for each option of printing is received. Examples of the option of printing may include N-Up copy, ID copy, BOKET copy, POSTER copy, Duplex Print copy, and Duplex Scan copy. For each option of printing, the user may selectively set whether to process the document in the monochrome mode or the color mode.

FIG. 7 illustrates an exemplary trim editing window 700 that sets a document to be processed in any one of a monochrome mode and a color mode for an option of printing. When a determination standard for determining a mode to process the document in the monochrome mode and the color mode is an option of printing, as described in operations 450 and 460, the trim editing window 700 may be displayed on the UI 130, as illustrated in FIG. 7.

As illustrated in FIG. 7, menu items indicate an option of printing and color/mono. Examples of the option of printing may include N-Up copy, ID copy, BOKET copy, POSTER copy, Duplex Print copy, and Duplex Scan copy. A user may select any one of the examples of the option of printing, and may set to process the document in the color mode or the monochrome mode for the selected option of printing.

Referring back to FIG. 3, in operation 320, scan data may be generated by scanning the document. The scanning unit 160 generates the scan data by scanning the document to which image data is written. When the image forming apparatus 100 is set to automatically determine whether the document is a monochrome document or a color document, color scan data may be generated by performing color scanning on the document.

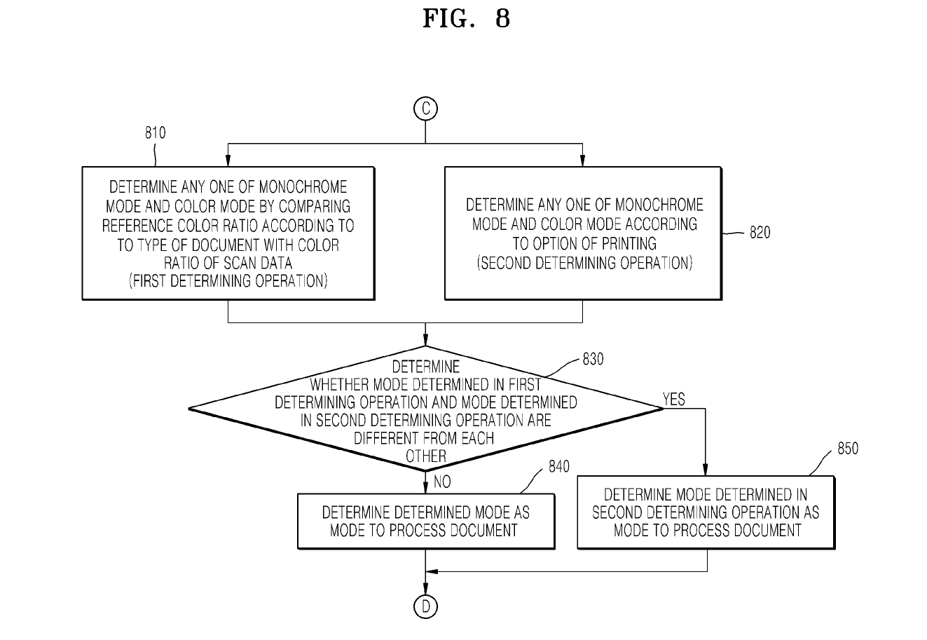

In operation 330, a mode to process the document may be determined from among the monochrome mode and the color mode based on the user's setting regarding the determination standard for determining a mode to process the document from among the monochrome mode and the color mode and the color ratio of the scan data, as illustrated, for example, in FIG. 8.

FIG. 8 is a flowchart illustrating an exemplary process of determining a mode to process a document from among a monochrome mode and a color mode.

In operation 810, a first determining operation of determining a mode as any one of the monochrome mode and the color mode is performed, for example, by comparing a reference color ratio according to a type of the document with a color ratio of scan data. A mode determining unit 114 of the controller 110 compares the color ratio of the scan data obtained by the image processing unit 112 with the reference color ratio, for example, according to the type of the document set by a user stored in the storage 140, determines a mode as the monochrome mode when the color ratio of the scan data is less than the reference color ratio according to the type of the document set by the user, and determines a mode as the color mode when the color ratio of the scan data exceeds the reference color ratio according to the type of the document set by the user.

In operation 820, a second determining operation of determining a mode as any one of the monochrome mode and the color mode may be performed according to an option of printing designated by the user when the image forming apparatus 100 is used. A mode determining unit 114 of the controller 110 compares the option of printing designated by the user when the image forming apparatus 100 is used with a document processing mode according to the option of printing which is preset by the user, and determines a mode as any one of the monochrome mode and the color mode according to each option of printing.

Operations 810 and 820 may be performed in parallel, as illustrated in FIG. 8, for example, simultaneously. When an option of printing is not designated when the image forming apparatus 100 is used, operation 820 may not be performed.

In operation 830, it may be determined whether the mode determined in the first determining operation and the mode determined in the second determining operation are different from each other. Both the modes determined in the first determining operation and the second determining operation may be color modes or may be monochrome modes. Otherwise, any one may be a color mode and the other may be a monochrome mode. For example, even though a color mode may be determined when the reference color ratio according to the type of the document is compared with the color ratio of the scan data, if it is set that a monochrome mode is determined as a mode when the option of printing is N-Up copy, the monochrome mode may be determined as a mode when the option of printing of N-Up copy is indicated. If it is determined that the modes determined in the first determining operation and the second determining operation are the same, the process proceeds to operation 840. Otherwise, if it is determined that the modes determined in the first determining operation and the second determining operation are different from each other, the process proceeds to operation 850.

In operation 840, since the modes determined in the first and second determining operations are the same, the determined mode is determined as a mode to process the document.

In operation 850, when the modes determined in the first and second determining operations are different from each other, a priority may be given to the mode determined in the second determining operation. For example, when the mode determined in the first determining operation is a color mode and the mode determined in the second determining operation is a monochrome mode, a mode is indicated as a monochrome mode. For example, if N-Up copy is performed for multiple, e.g., nine monochrome documents and a lesser number, e.g., one color document and the image forming apparatus 100 is set to process a document by automatically determining whether the document is a color document or a monochrome document, all of the multiple, e.g., nine monochrome documents may be processed in a color mode due to the one color document. In this case, if a user's setting that N-Up copy, which is an option of printing, corresponds to a monochrome mode is previously received, although one document is a color document, since a mode to process a document according to an option of printing is a monochrome mode, all of the documents subjected to N-Up copy may be printed in a monochrome mode.

Referring back to FIG. 3, in operation 340, the document may be processed according to a result of the determination. That is, when the controller 110 determines the monochrome mode as a mode to process the document, the image forming unit 170 processes the document in the monochrome mode. When the controller 110 determines the color mode as a mode to process the document, the image forming unit 170 processes the document in the color mode.

According to an exemplary embodiment, when a document is processed in a monochrome mode or a color mode in an image forming apparatus, an accuracy of determining a mode from among the monochrome mode and the color mode may be improved and the image forming apparatus may be used to maximally correspond to a user's intention.

A method of processing a document in an image forming apparatus, according to an exemplary embodiment of the present disclosure may be implemented as an executable program, and may be executed by a computer, e.g., general-purpose digital computer that runs the program by using a computer-readable recording medium. Examples of the computer-readable medium include storage media such as magnetic storage media (e.g., read only memories (ROMs), floppy discs, or hard discs), optically readable media (e.g., compact disk-read only memories (CD-ROMs) or digital versatile disks (DVDs)), etc.

While the present disclosure has been particularly shown and described with reference to exemplary embodiments thereof by using specific terms, the embodiments and terms have merely been used to explain the present disclosure and should not be construed as limiting the scope of the present disclosure as defined by the claims.

What is claimed is:

1. A method of processing a document in an image forming apparatus, the method comprising:
receiving a user's setting regarding a determination standard for determining a mode to process the document from among a monochrome mode and a color mode;
generating scan data by scanning the document;
determining a mode to process the document from among the monochrome mode and the color mode based on the user's setting regarding the determination standard and a color ratio of the scan data; and
processing the document based on a result of the determination.

2. The method of claim 1, wherein the receiving comprises:
displaying at least one determination standard, and
receiving the user's setting regarding the at least one determination standard for determining a mode to process the document from among the monochrome mode and the color mode.

3. The method of claim 2, wherein the receiving comprises, when the at least one determination standard is a reference color ratio according to a type of the document, receiving the user's setting regarding a type of the document and the reference color ratio for determining a mode to process the document from among the monochrome mode and the color mode according to each type of the document.

4. The method of claim 3, wherein the receiving comprises, when a background other than a portion of the document in which an image is formed has a color, further receiving the user's setting regarding whether to exclude the color of the background when the color ratio of the scan data is calculated.

5. The method of claim 3, wherein the reference color ratio ranges from about 0% to about 100%.

6. The method of claim 2, wherein the receiving comprises, when the at least one determination standard is options of printing, receiving the user's setting to process the document in any one of the monochrome mode and the color mode according to each option of printing.

7. The method of claim 1, wherein the determination standard is a reference color ratio according to a type of the document or an option of printing.

8. The method of claim 7, wherein the determining of the mode to process the document comprises:
performing a first determining operation of determining a mode as any one of the monochrome mode and the color mode by comparing the reference color ratio according to the type of the document with the color ratio of the scan data,
performing a second determining operation of determining a mode as any one of the monochrome mode and the color mode according to the option of printing, and
determining any one of the mode determined in the first determining operation and the mode determined in the second determining operation as a mode to process the document.

9. The method of claim 8, wherein the determining of the mode to process the document comprises, when the mode determined in the first determining operation and the mode determined in the second determining operation are different from each other, giving a priority to the mode determined in the second determining operation.

10. A computer-readable recording medium having embodied thereon a program for executing the method of claim 1 in a computer.

11. An image forming apparatus comprising:
a user interface (UI) that receives a user's setting regarding a determination standard for determining a mode to process a document from among a monochrome mode and a color mode;
a scanning unit that generates scan data by scanning the document;
a controller that determines a mode to process the document from among the monochrome mode and the color mode based on the user's setting regarding the determination standard and a color ratio of the scan data; and
an image forming unit that processes the document according to a result of the determination.

12. The image forming apparatus of claim 11, wherein the UI displays at least one determination standard and receives the user's setting regarding the at least one determination standard for determining a mode to process the document from among the monochrome mode and the color mode.

13. The image forming apparatus of claim 12, wherein when the at least one determination standard is a reference color ratio according to a type of the document, the UI receives the user's setting regarding a type of the document and the reference color ratio for determining a mode to process the document from among the monochrome mode and the color mode according to each type of the document.

14. The image forming apparatus of claim 13, wherein when a background other than a portion of the document in which an image is formed has a color, the UI further receives the user's setting regarding whether to exclude the color of the background when the color ratio of the scan data is calculated.

15. The image forming apparatus of claim 13, wherein the reference color ratio ranges from about 0% to about 100%.

16. The image forming apparatus of claim 12, wherein when the at least one determination standard is options of printing, the UI receives the user's setting to process the document in any one of the monochrome mode and the color mode according to each option of printing.

17. The image forming apparatus of claim 11, wherein the determination standard is a reference color ratio according to a type of the document and an option of printing.

18. The image forming apparatus of claim 17, wherein the controller performs a first determining operation of determining a mode as any one of the monochrome mode and the color mode by comparing the reference color ratio according to the type of the document with the color ratio of the scan data, performs a second determining operation of determining a mode as any one of the monochrome mode and the color mode according to the option of printing, and determines any one of the mode determined in the first determining operation and the mode determined in the second determining operation as a mode to process the document.

19. The image forming apparatus of claim 18, wherein when the mode determined in the first determining operation and the mode determined in the second determining operation are different from each other, the controller gives a priority to the mode determined in the second determining operation.

20. The image forming apparatus of claim 11, further comprising a storage that stores information about the user's setting regarding the determination standard.

21. A method of processing a document in an image forming apparatus that generates scan data by scanning a document, the method comprising:
receiving an input regarding a standard for determining a mode to process the document from among a plurality of modes;
determining a mode to process the document from among the plurality of modes based on the input regarding the standard and the generated scan data; and
processing the document based on a result of the determination.

22. The method of processing a document of claim 21, wherein the mode to process the document is from among a monochrome mode and a color mode, and determining determines the mode to process the document from among the monochrome mode and the color mode based on the input regarding the determination standard and a color ratio of the scan data.

23. An user interface (UI) for an image forming apparatus that generates scan data by scanning a document, the UI comprising:
a display to receive a user's setting regarding a determination standard for determining a mode to process a document; and
a controller that determines a mode to process the document based on the user's setting regarding the determination standard and the scan data.

24. The user interface (UI) for an image forming apparatus of claim 22, wherein the mode to process the document is from among a monochrome mode and a color mode, and the controller determines the mode to process the document from among the monochrome mode and the color mode based on the user's setting regarding the determination standard and a color ratio of the scan data.
